(19) United States
(12) Patent Application Publication
(10) Pub. No.: US 2019/0345673 A1
(43) Pub. Date: Nov. 14, 2019

(54) APPARATUS FOR MEASURING THE DEWATERING OF A PAPER MACHINE AT DIFFERENT POINTS OF THE WET END AND A METHOD FOR IMPLEMENTING IT

(71) Applicant: RUNTECH SYSTEMS OY, kolho (FI)

(72) Inventor: Juha Karvinen, Siltakylae (FI)

(21) Appl. No.: 16/482,985

(22) PCT Filed: Jan. 11, 2018
(86) PCT No.: PCT/FI2018/050020

§ 371 Date: Aug. 1, 2019

(30) Foreign Application Priority Data
Feb. 2, 2017 (FI) 20175092

(51) Int. Cl. D21F 1/78; B01D 19/00; G01F 1/00; G01F 1/42; G01F 15/08; G01F 23/14; D21G 9/00

(52) U.S. Cl. CPC D21F 1/78; B01D 19/0042; G01F 1/002; D21G 9/0036; G01F 1/42; G01F 15/08; G01F 23/14; G01F 1/007

(57) ABSTRACT

The object of the invention is an apparatus and a method for measuring dewatering in the wet end of a paper machine. What is essential in the invention is that the measuring system (26) comprises an essentially horizontal inlet pipe (10) on the machine level (11), which pipe is installed in the measuring receptacle (27), and in that the separation of air (22) is performed in an expanded pipe section (15) made in the inlet pipe (10) and in the outlet pipe (16) connected to it. A weir plate is installed in the measuring receptacle (27) of the measuring system (26), the weir plate functioning as a measuring weir (8) for measuring the amount of the dewatering flow, and from a pressure difference transmitter (20) installed on one side, which transmitter measures the height of the water surface produced by the measuring weir (8) for measuring the amount of water (7).

The object of the invention is an apparatus, as defined in the preamble of claim 1, for measuring the dewatering of a paper machine at different points of the wet end. In the invention, the water 7 removed from a roll 6 of the apparatus by means of centrifugal force or blowing is collected most preferably in a trough 3, or corresponding water receptacle, and is conducted by gravity along an inlet pipe 10 to a measuring system for measuring the dewatering at the wet end of the paper machine. The invention also relates to a method according to claim 11.

It is generally known in the art that when manufacturing paper, chemical pulp and board, different techniques for removing water from the fiber/water mixture, i.e. from the web, are used at the wet end of the machine. Water is separated from the web by means of centrifugal forces, negative pressure and/or wet pressing. The terms ‘paper web’ and ‘paper machine’ used hereinafter refer to all the aforementioned products and productions. It is important to measure the water separated from the web in different parts of the machine in order to optimize production efficiency. It is also worth measuring the water removed from the fabrics used in the press section for optimizing the machine and for fabric development.

Dewatering of the Web

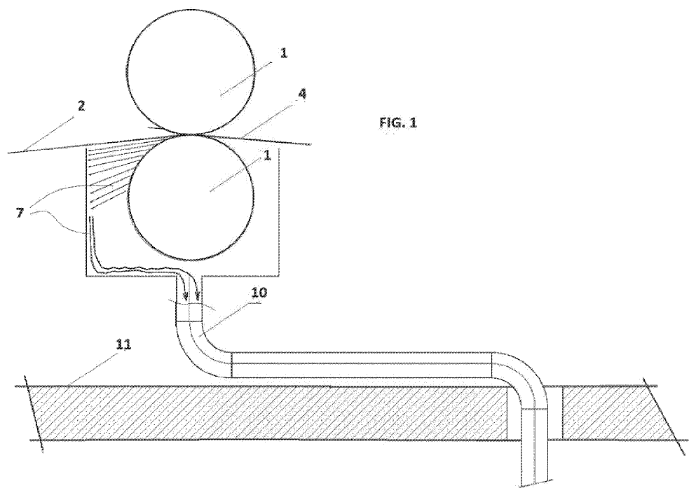

One typical solution according to the state of the art, which is disclosed in specification U.S. Pat. No. 6,053,039, is the dewatering principle presented in FIG. 1, whereby water 7 is removed from the surface of a rotating roll 1 by means of centrifugal force or blowing. In such a case, water is pressed from the paper web 4 and/or from the press fabric 2 into holes or grooves in the roll by means of negative pressure or mechanical pressing. The water thus removed is collected in a trough and conducted in a pipe 5 by gravity into a container generally disposed in a basement below the machine level 6, from where it is pumped back into the process.

Measurement of Dewatering

Currently, magnetic flow meters are used to measure the flow rate of the water removed with the water drainage technique presented above. One problem, however, is that the drainage waters of a paper machine contain a lot of air. For this reason, with liquids containing air all the devices measuring the flow velocity of the liquid give a false result, as also does a magnetic flow meter, because the air content increases the flow velocity. Therefore, a second technique is used, i.e. weir flow measurement, that functions better with liquids containing air. Conventional weir flow measurement uses a V-orifice weir, the height of the surface formed by the weir being measured either with a pressure transmitter or with a surface height meter. In all measurements functioning on the weir principle, it is important that the flow velocity before the weir is controlled. In V-orifice measurements, a relatively long and straight pipe is needed before the measurement. A problem with a V-weir in a paper machine is the space requirement and the solids in the flows that easily lodge in the sharp bottom corner of the weir.

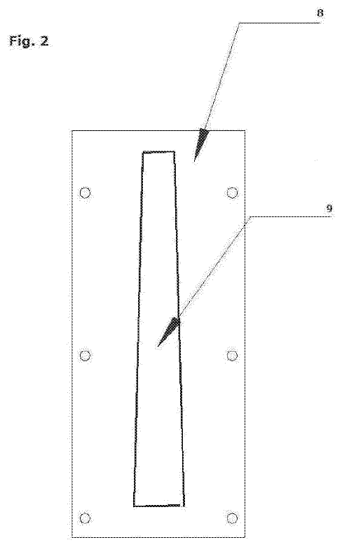

Another solution known from specifications U.S. Pat. No. 5,875,675 and US6053 is the weir plate 8 according to FIG. 2, the weir plate being replaceable depending on the flow rate and having an A-shaped 9 weir orifice in it. This type of solution allows solids to pass through because the bottom part of the weir is broad. The high top part, in turn, facilitates the measurement of surface height because the weir height is much higher than with a V-weir. The aforementioned specifications describe a weir measurement wherein water falls into a measuring receptacle from above. In specification U.S. Pat. No. 5,875,675, flow velocity with a weir orifice is controlled by conducting flows coming from different directions to meet, in which case the flow velocity is nullified, or according to specification U.S. Pat. No. 6,053,039, by conducting the water via an orifice, i.e. a water seal, below the weir for measurement.

Drawbacks and Problems of Prior Art

The measuring principles described above are widely used nowadays in the paper industry. However, they have some essential problems. Firstly, conducting water from above downwards for measuring requires a lot of space in the height direction. According to the state of the art, the meter must often be installed down in a basement in flow measurement of a trough. Piping costs increase, but the most detrimental issue from the viewpoint of the system is the high flow velocity of the water falling downwards, which distorts the measurement result. In addition to the high flow velocity, the high air content brought along with the water falling downwards also distorts the measurement result. The detrimental noise produced by falling water is also a problem.

The solution according to the invention is characterized by what is disclosed in the claims.

### BRIEF DESCRIPTION OF THE INVENTION

In the following a new system for measuring the drainage waters of a paper machine will be disclosed, which system resolves the problems known in the art and presented above.

According to the invention, a solution has been achieved wherein a new type of apparatus with which a method for measuring dewatering at the wet end of a paper machine can be utilized more efficiently both in dewatering points subject to atmospheric pressure and in dewatering points subject to negative pressure.

In the following, the invention will be described in more detail with reference to the attached drawings, wherein:

FIG. 1 presents a representation of a solution according to what is known in the art.

FIG. 2 presents a typical A-shaped weir orifice of a measuring weir.

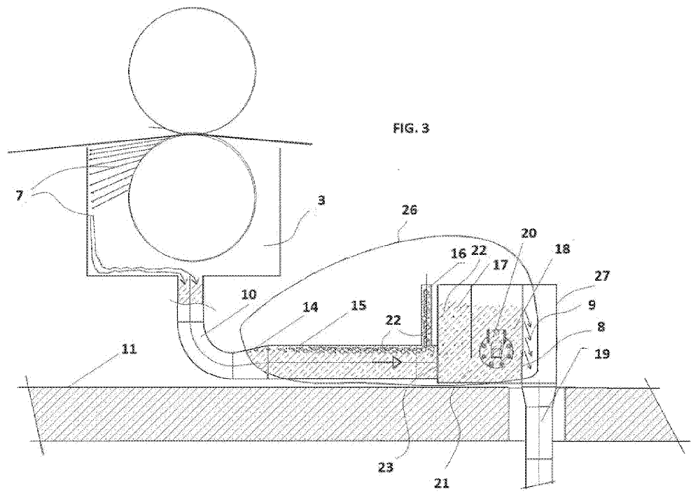

FIG. 3 presents a preferred embodiment of the solution according to the invention.

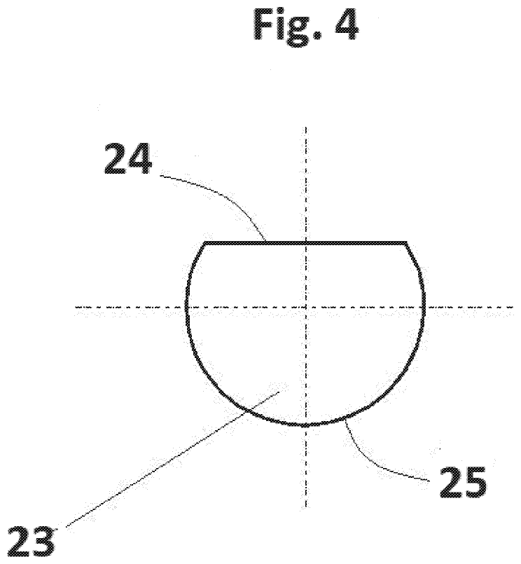

FIG. 4 presents a sectioned view of an inlet orifice entering the measuring receptacle.

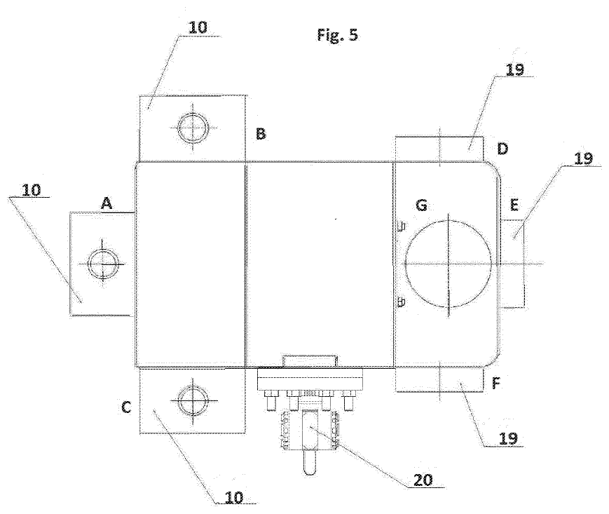

FIG. 5 presents the flow directions of the inlet pipes and outlet pipes of the measuring receptacle as viewed from above from a solution according to the invention.

FIG. 3 presents an apparatus according to the invention, the apparatus forming a measuring system 26, as well as a method implemented with it for measuring dewatering. More precisely, FIG. 3 presents a partially sectioned side view of the whole apparatus and of the structural parts comprised in it, as well as its operation. According to the invention, the drainage water 7 is guided from the trough according to the state of the art, of FIG. 1, and is measured in such a way that the drainage water 7 does not need to be conducted to a container in a basement below the machine level 11. In the invention, a new solution is sought for a trough water meter for the drainage waters 7 of a paper machine, with which solution the drawbacks of prior art are eliminated.

In the measuring system 26 according to the invention, the water 7 removed from the surface of a roll 6 is collected in a trough 3 and conducted along an inlet pipe 10 into the bottom part of the measuring receptacle 27 of the measuring system. The removal of air is implemented in the measuring system 26 with an expansion made in the inlet pipe 10, most preferably with an eccentric pipe reducer 14, which expands the internal volume of the pipe for separating air 22 from the water 7. The air 22 traveling along with the flow of the removed water 7 is in this way separated into the top part of the expanded pipe 15 and is guided onwards into an outlet pipe 16 that is open at the top. Most of the air 22 discharges along the pipe 16 and the rest of the remaining air 22 is separated along with the flow in the deaeration chamber 17. The removed water 7 flows from the deaeration chamber 17 via a water seal 21 into the measuring chamber 18, in which is most preferably the A-shaped 9 weir plate according to FIG. 2, which functions as a measuring weir 8.

According to what is presented above, what is essential in the invention is that the measuring chamber 18, the deaeration chamber 17, together with the inlet pipe 10 and the pipe section 15 expanded with a pipe reducer 14 formed in it for deaerating, as well as with the outlet pipe 16 open at the top, form receptacles uniting integrally with each other. In this way, the large water capacity important to the measuring system 26 according to the invention is achieved, the capacity allowing a calm, controlled and air-free flow to the measuring weir 8.

In the invention, a pressure transmitter 20 measures the height of the water level produced by the measuring weir 8. A transmitter 20 that is provided with e.g. a 50 mm membrane is used in the solution. What is essential is that the membrane of the transmitter does not clog with dirt, such as e.g. a thin pressure transmission pipe according to what is known in the art. In addition, the transmitter 20 is situated in such a way that the center line of the membrane is level with the bottom surface of the weir 8. The size of the measuring receptacle 27 functioning as a meter of the measuring system 26 depends on the flow rates; for example, the height*width*depth for a maximum flow of 1000 l/min are 0.6*0.7*0.5 m.

FIG. 4 presents the shape of the cross-section of the orifice 23 entering the deaeration chamber 17 of the measuring receptacle 27. The cross-section is most preferably essentially a D shape that is turned 90° in such a way that the vertical arm 24 of the letter D is above on the horizontal plane, forming a horizontal top part. This avoids the air 22 separated in the expanded pipe section 15 being directed into the deaeration chamber 17. More precisely, the D-shaped cross-section of the orifice 23 entering the deaeration chamber 17 is dimensioned in such a way that the distance of the inside surface of the horizontal top part 24 of the orifice 23 from the bottom surface 25 of said orifice 23 is the same as the cross-section of the inside surface of the inlet pipe 10. In other words, the vertical cross-sections of the D-shaped orifice 23 and of the inlet pipe 10 before the pipe reducer 14 are of the same magnitude.

The solution according to the invention saves space in the height direction because the removed water 7 is guided along the inlet pipe 10 through the pipe section 15 expanded with a pipe reducer 14 and through the D-shaped orifice 23 into the essentially horizontal bottom part of the deaeration chamber 17. The outlet pipe 19 leaving from the measuring chamber 18 of the measuring system 26 is oriented either downwards or horizontally, depending on the space in which the measuring chamber 18 is installed. This property reduces the height space required to the minimum; that being the case, the whole measuring system 26 can be installed on the machine level 11.

FIG. 5 presents the inlet pipe 10 and the expansion 15 formed in it, as well as the options for the flow directions of the outlet pipe 19 leaving from the measuring receptacle 27 of the measuring system 26 as viewed from the top direction to the measuring receptacle 27. The options for the inlet pipes 10 are marked with the letters A-C and for the outlet pipes 19 with the letters D-G, and also the installation location of the pressure transmitter 20 in relation to them. What is essential to the invention is that there can be, if necessary, a plurality, most preferably 2-4 units, both of inlet pipes 10 and of outlet pipes 19, if required by the installation site. In this way, savings can be made in, inter alia, piping costs. This property is not in solutions according to the state of the art.

It is obvious, according to what is presented above, that considerable advantages are gained with the invention. The solution according to the invention is considerably more compact and less expensive to manufacture than a solution describing the state of the art, and also the measurement result is better.

What is essential in the measuring system is that it comprises:
an essentially horizontal inlet pipe 10 on the machine level 11, which pipe is installed in the bottom part of the inlet of the deaeration chamber 17 comprised in the measuring receptacle 27,
a two-part separation of the air 22 in the water 7 in such a way that the first part comprises an expanded pipe section 15 made in the inlet pipe 10 and the outlet pipe 16 connected to it, for directing away from the pipe section 15 the air 22 separated from the water 7,
the second part of the separation of air 22 comprises a deaeration chamber 17 comprised in the measuring receptacle, one wall of which chamber is open at the bottom, functioning as a water seal 21, in which the remainder of the air 22 in the water 7 is separated to the surface of the deaeration chamber 17 and the water 7 is conducted from the wall that is open at the bottom functioning as a water seal 21 to the other side of said wall,
forming a measuring chamber 18 comprised in the measuring receptacle 27 in such a way that a weir plate is installed on the opposite side of the water seal 21, the weir plate functioning as a measuring weir 8 for measuring the amount of the dewatering flow, and a pressure difference transmitter 20 installed on one side, which transmitter measures the height of the water surface produced by the measuring weir 8 for measuring the amount of water 7.

It is obvious to the person skilled in the art that the invention is not limited to the embodiments presented above, but that it can be varied within the scope of the claims presented below, which form a method and an apparatus for the measuring system 26 according to the invention.

1. Apparatus for measuring the dewatering of a paper machine at different points of the wet end in such a way that the water (7) removed from a roll (6) by means of centrifugal force or blowing is collected in a trough (3), or corresponding receptacle, and is conducted by gravity along an inlet pipe (10), characterized in that the apparatus functioning as a measuring system (26) comprises:
an essentially horizontal inlet pipe (10) on the machine level (11), which pipe is installed in the bottom part of the inlet of the deaeration chamber (17) comprised in the measuring receptacle (27),
a two-part separation of the air (22) in the water (7) in such a way that the first part comprises an expanded pipe section (15) made in the inlet pipe (10) and the outlet pipe (16) connected to it, for directing away from the pipe section (15) the air (22) separated from the water (7),
the second part of the separation of air (22) comprises a deaeration chamber (17) comprised in the measuring receptacle, one wall of which chamber is open at the bottom, functioning as a water seal (21), in which the remainder of the air (22) in the water (7) is separated to the surface of the deaeration chamber (17) and the water (7) is conducted from the wall that is open at the bottom functioning as a water seal (21) to the other side of said wall,
forming a measuring chamber (18) comprised in the measuring receptacle (27) in such a way that a weir plate is installed on the opposite side of the water seal (21), the weir plate functioning as a measuring weir (8) for measuring the amount of the dewatering flow, and a pressure difference transmitter (20) installed on one side, which transmitter measures the height of the water surface produced by the measuring weir (8) for measuring the amount of water (7).

2. Apparatus according to claim 1, characterized in that an expanded pipe section (15) is made with an eccentric pipe reducer (14) in the inlet pipe (10).

3. Apparatus according to claim 1 or 2, characterized in that the outlet pipe (16) is connected to the pipe section (15) before the inlet of the deaeration chamber (17) comprised in the measuring receptacle (27).

4. Apparatus according to claim 1, characterized in that the cross-section of the orifice (23) of the inlet of the inlet pipe (10) entering the bottom part of the deaeration chamber (17) comprised in the measuring receptacle is essentially a D shape turned to be horizontal, in such a way that the distance of the inside surface of the horizontal top part (24) of the orifice (23) from the bottom surface (25) of the orifice (23) is the same as the cross-section of the inside surface of the inlet pipe (10).

5. Apparatus according to claim 4, characterized in that the dimension of the cross-section of the inlet orifice (23) that is a D shape turned to be horizontal is the same as the dimension of the vertical cross-section of the inlet pipe (10) before the pipe reducer (14).

6. Apparatus according to claim 1, characterized in that the weir plate functioning as a measuring weir (8) is essentially A-shaped (9).

7. Apparatus according to claim 1, characterized in that the pressure transmitter (20) is situated in such a way that the center line of the membrane is level with the bottom surface of the measuring weir (8).

8. Apparatus according to claim 1, characterized in that the whole apparatus is installed at machine level (11) in such a way that the outlet pipe (19) leaving from the measuring receptacle (27) is oriented either downwards or horizontally, depending on the space in which the measuring chamber (18) is installed.

9. Apparatus according to claim 1, characterized in that in one apparatus there is, if necessary, a plurality, most preferably 2-4 units, of both inlet pipes (10) and outlet pipes (19).

10. Apparatus according to claim 1, characterized in that the water capacity required by the apparatus is achieved by forming to each other the inlet pipe (10) and the pipe section (15) expanded with a pipe reducer (14) formed in it for air separation as well as an outlet pipe (16) open at the top and a measuring receptacle installed at the end of the inlet pipe (10), which measuring receptacle comprises a deaeration chamber (17) and a measuring chamber (18), forming receptacles integrally joined to each other enabling the controlled and air-free flow of water (8) to the measuring weir (28) and measurement by means of a pressure difference transmitter (20), which transmitter measures the height of the water surface produced by the measuring weir (28) for measuring the dewatering (8).

11. Method for measuring the dewatering of the wet end of a paper machine at different points in such a way that the water (7) removed from a roll (6) by means of centrifugal force or blowing is collected in a trough (3), or corresponding water receptacle, and is conducted by gravity along an inlet pipe (10), characterized in that in the method according to the measuring system (26)
measurement of the removed water (8) is performed completely on the machine level (11)
water (7) is directed from the trough (3) along an essentially horizontal inlet pipe (10) that is installed in the bottom part of the inlet of the deaeration chamber (17) comprised in the measuring receptacle (27),
deaeration (22) of the water (7) is performed in two parts in such a way that in the first part water (7) is guided into an inlet pipe (10) and onwards into an expanded pipe section (15) made in it, in which pipe section the air (22) separates from the water (7) into the top part of the pipe (15) and the separated air (22) is guided out of the pipe section (15) along an outlet pipe (16) connected to it,
in the second part of the separation of air (22) the water (7) is guided into a deaeration chamber (17) comprised in the measuring receptacle (27), one wall of which chamber is open at the bottom, functioning as a water seal (21), in which the remainder of the air (22) in the water (7) is separated to the surface of the deaeration chamber (17) and the water (7) is conducted from the wall that is open at the bottom functioning as a water seal (21) to the other side of said wall,
in the method, the measurement is performed in the measuring chamber (18) comprised in the measuring receptacle (27) in such a way that installed on the opposite side of the water seal (21) is a weir plate, which functions as a measuring weir (8) for measuring the amount of the dewatering flow, and a pressure difference transmitter (20) installed on one side, which transmitter measures the height of the water surface produced by the measuring weir (8) for measuring the amount of water (7).

12. Method according to claim 11, characterized in that in the method, for separating air (22), an expanded pipe section (15) is made with an eccentric pipe reducer (14) in the inlet pipe (10).

13. Method according to claim 11, characterized in that, for removing the separated air (22), the outlet pipe (16) is connected to the pipe section (15) before the inlet of the deaeration chamber (17) comprised in the measuring receptacle (27).

14. Method according to claim 11, characterized in that the cross-section of the orifice (23) of the inlet of the inlet pipe (10) entering the bottom part of the deaeration chamber (17) comprised in the measuring receptacle (27) is essentially a D shape turned to be horizontal in such a way that, for increasing the efficiency of deaeration, the distance of the inside surface of the horizontal top part (24) of the orifice (23) from the bottom surface (25) of the orifice (23) is the same as the cross-section of the inside surface of the inlet pipe (10).

15. Method according to claim 11, characterized in that the weir plate functioning as a measuring weir (8) for measuring the water (7) is essentially A-shaped (9).

16. Method according to claim 11, characterized in that, for measuring the water (7), the pressure transmitter (20) is situated in such a way that the center line of the membrane is level with the bottom surface of the measuring weir (8).

17. Method according to claim 11, characterized in that in the method the water capacity required by the measuring system (26) is achieved by forming to each other the inlet pipe (10) and the pipe section (15) expanded with a pipe reducer (14) formed in it for air separation as well as an outlet pipe (16) open at the top and also a measuring receptacle (27) installed at the end of the inlet pipe (10), which measuring receptacle (27) comprises a deaeration chamber (17) and a measuring chamber (18), forming receptacles integrally joined to each other, enabling the controlled and air-free flow of water (7) to the measuring weir (8) and measurement by means of the pressure difference transmitter (20), which transmitter measures the height of the water surface produced by the measuring weir (8) for measuring the dewatering (7).
